(19) United States
(12) Patent Application Publication
(10) Pub. No.: US 2009/0290504 A1
(43) Pub. Date: Nov. 26, 2009

(54) METHOD AND APPARATUS FOR DETECTING ATTENUATION OF DOWNLINK CHANNEL IN BASEBAND EPCN SYSTEM

(76) Inventor: Yang YU, Beijing (CN)

Correspondence Address: LADAS & PARRY LLP, 224 SOUTH MICHIGAN AVENUE, SUITE 1600, CHICAGO, IL, 60604, US

(21) Appl. No.: 12/470,623

(22) Filed: May 22, 2009

(30) Foreign Application Priority Data
May 26, 2008 (CN) 200810097438.0

(51) Int. Cl. H04L 12/26

(52) U.S. Cl. 370/252

(57) ABSTRACT

The present invention discloses a method and apparatus for detecting attenuation of a downlink channel in a baseband Ethernet Passive Coaxial Network (EPCN) system. The method includes: instructing, by a Coax Line Terminal (CLT) in a downlink time period, a Coax Network Unit (CNU) to measure a signal received by the CNU; and obtaining, by the CLT, the attenuation of the downlink channel of the CNU according to a measuring result sent by the CNU. Through the solution provided by the present invention, it is possible to obtain the attenuation of the downlink from the CLT to any CNU in the EPCN system, which facilitates engineers to locate problems and settle network troubles.

### FIELD OF THE INVENTION

The present invention relates to communication fields, and more particularly, to method and apparatus for detecting attenuation of a downlink channel in a baseband Ethernet Passive Coaxial Network (EPCN) system.

### BACKGROUND OF THE INVENTION

The baseband EPCN system refers to an Ethernet running on a coaxial network and adopts a point-to-multipoint coaxial distribution network as physical layer transmission medium. The coaxial distribution network may have a topology structure, such as a star topology or a tree topology, etc.

The structure of the baseband EPCN system is shown in FIG. 1. A typical baseband EPCN system includes a Coax Line Terminal (CLT), a Coax Network Unit (CNU) and a coaxial distribution network, etc. The CLT is located in corridor or where a community optical node is located. The CNU is located where the user resides and functions as a Customer Premise Equipment (CPE) to access a user terminal, or is integrated with products such as corridor switch to function as an uplink interface of the corridor switch. The coaxial distribution network is a network from a CATV optical node location to user's home. Besides coaxial cable, the coaxial distribution network further includes apparatuses such as active amplifier, branch/distributor, etc.

In a current baseband EPCN system, one CLT may be coupled to multiple (e.g. 24) CNUs. As to downlinks from the CLT to the CNUs, attenuation situation may be quite different, which results in different Signal to Noise Ratios (SNRs) and different bit-error-rates of the CNUs. Operators hope that the line attenuation from operator equipment CLT to customer equipment CNU can be displayed automatically. Therefore, when an error bit emerges in the customer equipment, it is possible to determine quickly whether the communication error bit is caused by a line problem or other problems. However, the conventional technology can not automatically measure the line attenuation from the CLT to the customer equipment CNU.

### SUMMARY OF THE INVENTION

Embodiments of the present invention provide a method and apparatus for detecting attenuation of a downlink channel in a baseband Ethernet Passive Coaxial Network (EPCN) system, which can detect line attenuation from a Coax Line Terminal (CLT) to a customer equipment Coax Network Unit (CNU) in the baseband EPCN system.

According to an embodiment of the present invention, a method for detecting attenuation of a downlink channel in a baseband Ethernet Passive Coaxial Network (EPCN) system is provided. The method includes:

instructing, by a Coax Line Terminal (CLT) in a downlink time period, a Coax Network Unit (CNU) to measure a signal received by the CNU; and

obtaining, by the CLT, the attenuation of the downlink channel of the CNU according to a measuring result sent by the CNU.

According to an embodiment of the present invention, a method for detecting attenuation of a downlink channel of a baseband Ethernet Passive Coaxial Network (EPCN) system is provided. The method includes:

receiving, by a Coax Network Unit (CNU), an instruction sent by a Coax Line Terminal (CLT) in a downlink time period;

measuring, by the CNU, a signal received from the CLT according to the instruction and obtaining a measuring result; and

sending, by the CNU, the measuring result to the CLT.

According to another embodiment of the present invention, a Coax Line Terminal (CLT) is provided. The CLT includes:

an instruction sending unit, adapted to instruct a Coax Network Unit (CNU) in a downlink time period to measure a signal received by the CNU; and

an attenuation obtaining unit, adapted to obtain attenuation of a downlink channel of the CNU according to a measuring result sent by the CNU.

According to another embodiment of the present invention, a Coax Network Unit (CNU) is provided. The CNU includes:

a Media Access Control (MAC) layer chip, adapted to instruct a PHY chip to measure a signal received by the CNU when receiving an instruction sent by a Coax Line Terminal (CLT) in a downlink time period, and send a measuring result obtained by the PHY chip to the CLT; and

the PHY chip, adapted to measure the signal received from the CLT according to the instruction received by the MAC layer chip and obtain the measuring result.

Through the solution provided by the present invention, it is possible to obtain the attenuation of a downlink from the CLT to any CNU in the baseband EPCN system, which facilitates engineers to locate problems and settle network troubles.

### BRIEF DESCRIPTION OF THE DRAWINGS

FIG. 1 is a schematic diagram illustrating a structure of a conventional baseband EPCN system.

FIG. 2 is a flowchart illustrating a method for detecting attenuation of a downlink channel in the baseband EPCN system according to an embodiment of the present invention.

FIG. 3 is a flowchart illustrating a method for detecting attenuation of a downlink channel in the baseband EPCN system according to an embodiment of the present invention.

FIG. 4 is a schematic diagram illustrating a structure of a CLT according to an embodiment of the present invention.

FIG. 5 is a schematic diagram illustrating a structure of a CNU according to an embodiment of the present invention.

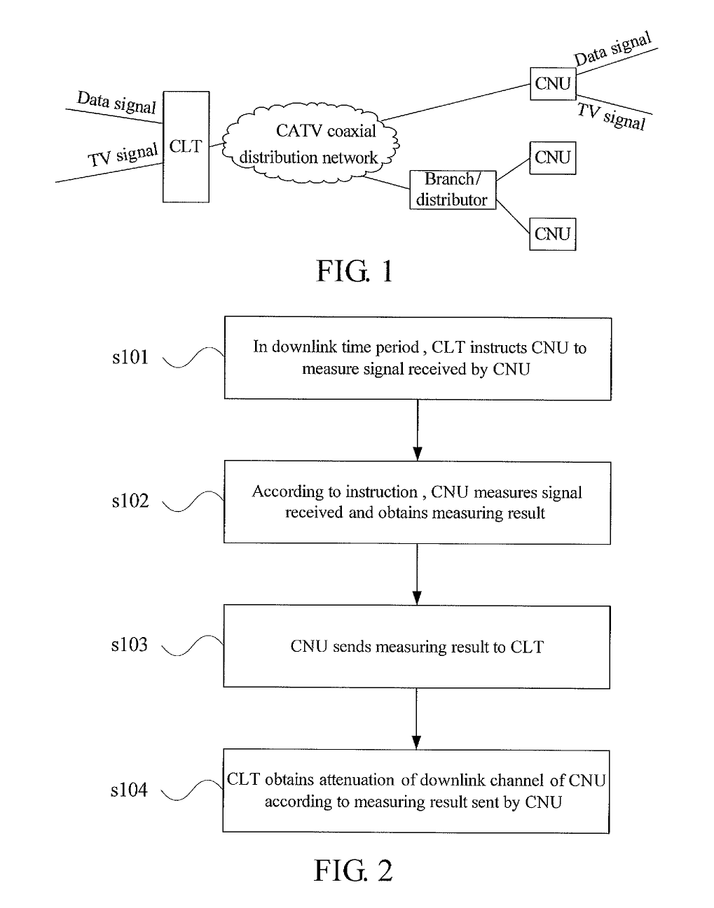

### DETAILED DESCRIPTION OF THE INVENTION

The present invention will be described hereinafter in detail with reference to accompanying drawings and embodiments.

In the baseband EPCN system, downlink signals and uplink signals share one physical channel, i.e. the downlink signals from the CLT to the CNU and the uplink signals from the CNU to the CLT share the same channel in a time-division manner. In a current EPCN system, each CNU keeps its receiving window open when the CNU sends no data. For each CNU, besides signals from the CLT, signals from other CNUs may also be received through the receiving window. Therefore, the CNU cannot determine whether a signal currently received is from the CLT or from other CNUs, thereby cannot determine a sampling point for the signal received.

In the EPCN system, both a downlink time slot and an uplink time slot of each CNU are assigned by the CLT. Therefore, the CLT may determine a time point when the CNU samples the signal received.

Based on the above analysis, embodiments of the present invention provide a method and an apparatus for detecting attenuation of a downlink channel in the baseband EPCN system. According to an embodiment of the present invention, the CLT determines a time point for sampling the signal received by the CNU and instructs the CNU to measure the signal received. After measuring the signal received, the CNU sends a measuring result to the CLT. The CLT obtains the attenuation of the downlink channel of the CNU according to the measuring result.

Particularly, the method for detecting the attenuation of the downlink channel in the baseband EPCN system according to an embodiment of the present invention is shown in FIG. 2. As shown in FIG. 2, the method includes the following.

Block s101: In a downlink time period, the CLT instructs the CNU to measure a signal received by the CNU.

Block s102: According to the instruction, the CNU measures the signal received and obtains a measuring result.

Block s103: The CNU sends the measuring result to the CLT.

Block s104: The CLT obtains the attenuation of the downlink channel of the CNU according to the measuring result sent by the CNU.

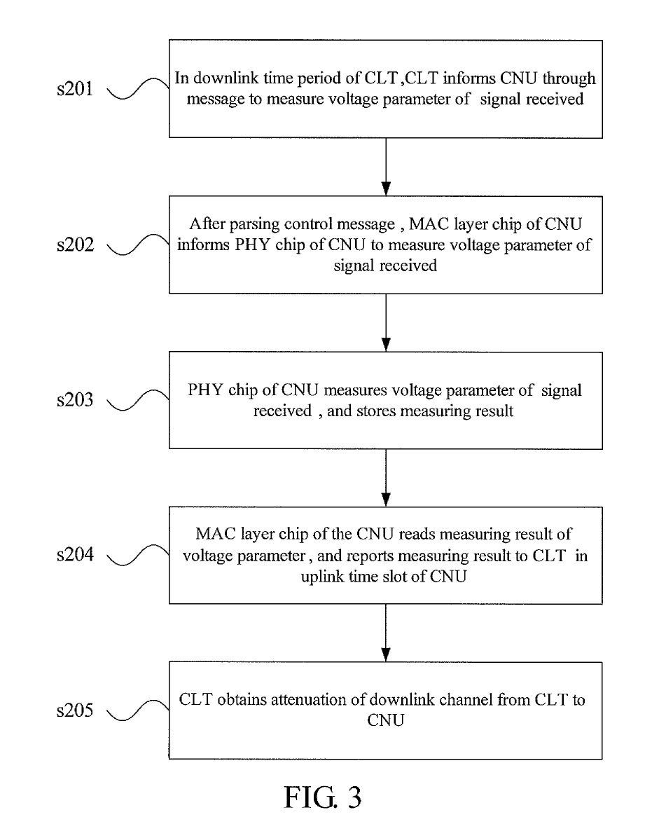

In a specific application scenario of the present invention, a method for detecting attenuation of a downlink channel in the baseband EPCN system is provided. As shown in FIG. 3, the method includes the following.

Block s201: In a downlink time period of the CLT, the CLT informs the CNU through a message to measure a voltage parameter of the signal received.

In particular, the CLT informs the CNU to measure the voltage parameter in the downlink time period. Because the CNU may receive signals from other CNUs in the uplink time period, if the CLT informs in the uplink time period the CNU to measure the voltage parameter of the signal received, the CNU may measure the signals from other CNUs. In other words, the CNU may measure the attenuation of a physical channel from another CNU to this CNU, but not from the CLT to the CNU.

Block s202: After parsing the message, a Media Access Control (MAC) layer chip of the CNU informs a PHY chip of the CNU to measure the voltage parameter of the signal received.

In particular, after receiving the message from the CLT, the MAC layer chip of the CNU immediately informs the PHY chip to measure the voltage parameter.

Block s203: The PHY chip of the CNU measures the voltage parameter of the signal received, and stores a measuring result of the voltage parameter of the signal received.

In particular, the PHY chip of the CNU completes the measurement before the downlink time period expires, and stores the measuring result in a corresponding measurement register.

Block s204: The MAC layer chip of the CNU reads the measuring result of the voltage parameter of the signal received, and reports the measuring result of the voltage parameter of the signal received to the CLT in an uplink time slot of the CNU.

Block s205: The CLT obtains the attenuation of the downlink channel from the CLT to the CNU.

In particular, when sending a signal, the CLT pre-stores a voltage parameter of the signal sent. The CNU measures the voltage parameter of the signal sent by the CLT after attenuated in the downlink channel from the CLT to the CNU. According to the two voltage parameters, the CLT may obtain the attenuation of the physical channel from the CLT to the CNU.

Embodiments of the present invention also provide a system for detecting attenuation of a downlink channel in the baseband EPCN system. The system includes the CLT and the CNU. The CLT is adapted to instruct, in a downlink time period, the CNU to measure a voltage parameter of a signal received by the CNU, and obtain the attenuation of the downlink channel from the CLT to the CNU according to a measuring result sent by the CNU. The CNU is adapted to measure the signal received from the CLT after being instructed by the CLT in the downlink time period, obtain the measuring result and send the measuring result to the CLT.

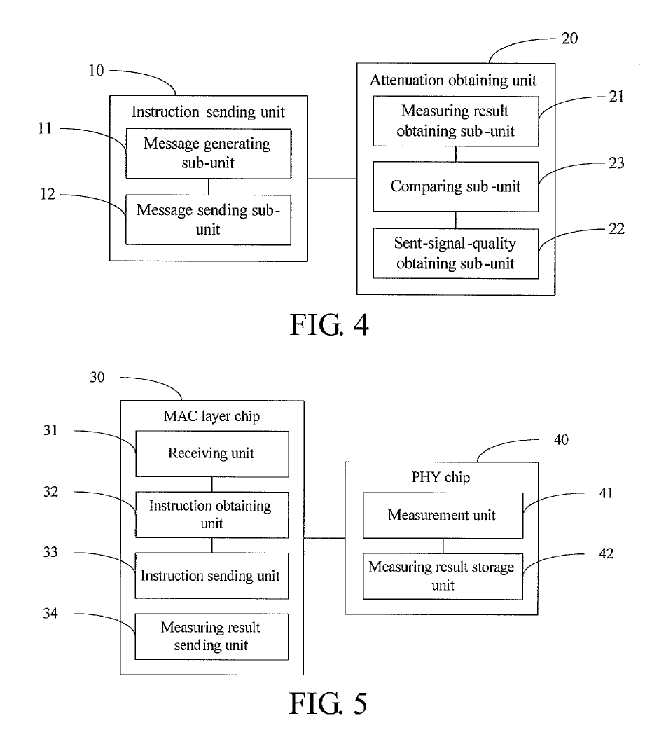

In particular, as shown in FIG. 4, the CLT includes:

an instruction sending unit 10, adapted to instruct, in the downlink time period, the CNU to measure the signal received by the CNU;

an attenuation obtaining unit 20, adapted to obtain the attenuation of the downlink channel from the CLT to the CNU according to the measuring result.

The instruction sending unit 10 includes:

a message generating sub-unit 11, adapted to generate a first message, and carry an instruction in the first message for instructing the CNU to measure the signal received; and

a message sending sub-unit 12, adapted to send the first message generated by the message generating sub-unit 11 to the CNU in the downlink time period.

The attenuation obtaining unit 20 includes:

a measuring result obtaining sub-unit 21, adapted to receive a second message sent by the CNU in the uplink time period, and obtain a measuring result carried in the second message;

a sent-signal-quality obtaining sub-unit 22, adapted to obtain a signal quality of the signal sent to the CNU; and

a comparing sub-unit 23, adapted to compare the measuring result obtained by the measuring result obtaining sub-unit 21 with the signal quality of the sent signal obtained by the sent-signal-quality obtaining sub-unit 23, and obtain the attenuation of the downlink channel of the CNU.

In particular, as shown in FIG. 5, the CNU includes:

a MAC layer chip 30, adapted to instruct a PHY chip 40 to measure a signal received by the CNU when receiving an instruction from the CLT in the downlink time period, and send a measuring result obtained by the PHY chip 40 to the CLT; and

the PHY chip 40, adapted to measure the signal received from the CLT according to the instruction received by the MAC layer chip 40, and obtain the measuring result.

The MAC layer chip 30 includes:

a receiving unit 31, adapted to receive the first message sent by the CLT in the downlink time period;

an instruction obtaining unit 32, adapted to obtain the instruction carried in the first message for measuring the signal received;

an instruction sending unit 33, adapted to instruct, according to the instruction obtained by the instruction obtaining unit 32, the PHY chip 40 to measure the signal received; and

a measuring result sending unit 34, adapted to add the measuring result obtained by the PHY chip 40 to a second message and send the second message to the CLT in an uplink time period.

The PHY chip 40 includes:

a measurement unit 41, adapted to measure the signal received from the CLT according to the instruction received by the MAC layer chip 30; and

a measuring result storage unit 42, adapted to store the measuring result obtained by the measurement unit 41, and provide the measuring result for the measuring result sending unit 34 of the MAC layer chip 30.

Through the methods and apparatuses provided by the embodiments of the present invention, the attenuation of a downlink channel from the CLT to any CNU in the baseband EPCN system may be obtained, which facilitates engineers to locate problems and settle the network troubles.

According to the above description of embodiments, it can be clearly understood by those skilled in the art that the present invention can be realized by software accompanying with necessary general hardware platforms, or by hardware. In many cases, the former is a preferred implementation manner. Based on this point, the essential part of the technical solution of the present invention or the part contributed to the prior art can be in the form of a software product, and the computer software product is stored in a storage medium and includes several codes to make a network apparatus perform the method in embodiments of the present invention.

The foregoing descriptions are only preferred embodiments of this invention. Any changes and modifications can be made by those skilled in the art without departing from the spirit of this invention and therefore should be covered within the protection scope as set by the appended claims.

What is claimed is:

1. A method for detecting attenuation of a downlink channel in a baseband Ethernet Passive Coaxial Network (EPCN) system, comprising:
instructing, by a Coax Line Terminal (CLT) in a downlink time period, a Coax Network Unit (CNU) to measure a signal received by the CNU; and
obtaining, by the CLT, the attenuation of the downlink channel of the CNU according to a measuring result sent by the CNU.

2. The method of claim 1, wherein the instructing the CNU to measure the signal received by the CNU comprises:
generating, by the CLT, a first message, and carrying an instruction in the first message for instructing the CNU to measure the signal;
sending, by the CLT, the first message to the CNU in the downlink time period.

3. The method of claim 1, wherein the obtaining the attenuation of the downlink channel of the CNU according to the measuring result sent by the CNU comprises:
receiving, by the CLT, a second message sent by the CNU in an uplink time period, obtaining the measuring result carried in the second message;
obtaining, by the CLT, a signal quality of the signal sent to the CNU;
comparing, by the CLT, the measuring result with the signal quality to obtain the attenuation of the downlink channel of the CNU.

4. The method of claim 2, further comprising:
after instructing by the CLT in the downlink time period the CNU to measure the signal,
receiving, by a Media Access Control (MAC) layer chip of the CNU, the first message sent by the CLT in the downlink time period, obtaining the instruction carried in the first message for instructing the CNU to measure the signal;
measuring, by a PHY chip of the CNU, the signal received from the CLT according to the instruction obtained by the MAC layer chip, and providing the measuring result for the MAC layer chip; and
adding, by the MAC layer chip, the measuring result into a second message, and sending the second message to the CLT in an uplink time period.

5. A method for detecting attenuation of a downlink channel of a baseband Ethernet Passive Coaxial Network (EPCN) system, comprising:
receiving, by a Coax Network Unit (CNU), an instruction sent by a Coax Line Terminal (CLT) in a downlink time period;
measuring, by the CNU, a signal received from the CLT according to the instruction and obtaining a measuring result; and
sending, by the CNU, the measuring result to the CLT.

6. The method of claim 5, wherein the receiving the instruction sent by the CLT in the downlink time period comprises:
receiving, by a Media Access Control (MAC) layer chip of the CNU, a first message sent by the CLT in the downlink time period; and
obtaining, by the MAC layer chip, the instruction from the first message for instructing the CNU to measure the signal.

7. The method of claim 6, wherein the measuring the signal received from the CLT according to the instruction and obtaining the measuring result comprises:
measuring, by a PHY chip of the CNU, the signal received from the CLT according to the instruction obtained by the MAC layer chip; and
storing, by the PHY chip of the CNU, the measuring result and providing the measuring result for the MAC layer chip.

8. The method of claim 7, wherein the sending the measuring result to the CLT comprises:
obtaining, by the MAC layer chip of the CNU, the measuring result stored by the PHY chip; and
adding, by the MAC layer chip of the CNU, the measuring result into a second message and sending the second message to the CLT in an uplink time period.

9. The method of claim 5, further comprising:
before receiving by the CNU the instruction sent by the CLT in the downlink time period,
generating, by the CLT, a first message, and carrying the instruction for instructing the CNU to measure the signal in the first message; and
sending, by the CLT, the first message to the CNU in the downlink time period.

10. The method of claim 5, further comprising:
after sending by the CNU the measuring result to the CLT,
receiving, by the CLT, a second message sent by the CNU in the uplink time period, obtaining the measuring result carried in the second message;
obtaining, by the CLT, a signal quality of the signal sent to the CNU; and
comparing, by the CLT, the measuring result sent by the CNU with the signal quality to obtain the attenuation of the downlink channel of the CNU.

11. A Coax Line Terminal (CLT), comprising:
an instruction sending unit, adapted to instruct a Coax Network Unit (CNU) in a downlink time period to measure a signal received by the CNU; and
an attenuation obtaining unit, adapted to obtain attenuation of a downlink channel of the CNU according to a measuring result sent by the CNU.

12. The CLT of claim 11, wherein the instruction sending unit comprises:
a message generating sub-unit, adapted to generate a first message, and carry an instruction for instructing the CNU to measure the signal in the first message; and
a message sending sub-unit, adapted to send the first message to the CNU in the downlink time period.

13. The CLT of claim 11, wherein the attenuation obtaining unit comprises:
a measuring result obtaining sub-unit, adapted to receive a second message sent by the CNU in an uplink time period, obtain the measuring result carried in the second message; and
a sent-signal-quality obtaining sub-unit, adapted to obtain a signal quality of the signal sent to the CNU; and
a comparing sub-unit, adapted to compare the measuring result obtained by the measuring result obtaining sub-unit with the signal quality obtained by the sent-signal-quality obtaining sub-unit, and obtain the attenuation of the downlink channel of the CNU.

14. A Coax Network Unit (CNU), comprising:
a Media Access Control (MAC) layer chip, adapted to instruct a PHY chip to measure a signal received by the CNU when receiving an instruction sent by a Coax Line Terminal (CLT) in a downlink time period, and send a measuring result obtained by the PHY chip to the CLT; and
the PHY chip, adapted to measure the signal received from the CLT according to the instruction received by the MAC layer chip and obtain the measuring result.

15. The CNU of claim 14, wherein the MAC layer chip comprises:
a receiving unit, adapted to receive a first message sent by the CLT in the downlink time period;
an instruction obtaining unit, adapted to obtain the instruction carried in the first message for instructing the CNU to measure the signal received from the CLT; and
an instruction sending unit, adapted to instruct, according to the instruction obtained by the instruction obtaining unit, the PHY chip to measure the signal; and
a measuring result sending unit, adapted to add the measuring result obtained by the PHY chip into a second message and send the second message to the CLT in an uplink time period.

16. The CNU of claim 14, wherein the PHY chip comprises:
a measurement unit, adapted to measure the signal received from the CLT according to the instruction received by the MAC layer chip; and
a measuring result storage unit, adapted store the measuring result obtained by the measurement unit, and send the measuring result to the MAC layer chip.
